(19) United States
(12) Patent Application Publication
(10) Pub. No.: US 2024/0251009 A1
(43) Pub. Date: Jul. 25, 2024

(54) SYSTEMS AND METHODS FOR BOUNDLESS FILE TRANSFER

(71) Applicant: RAKUTEN SYMPHONY SINGAPORE PTE. L.T.D., Singapore (SG)

(72) Inventor: Seung Hyun SON, Singapore (SG)

(21) Appl. No.: 18/012,428

(22) PCT Filed: Nov. 11, 2022
(86) PCT No.: PCT/US2022/049654

§ 371 Date: Dec. 22, 2022

(51) Int. Cl. H04L 67/06; H04L 67/306

(52) U.S. Cl. CPC H04L 67/06; H04L 67/306

(57) ABSTRACT

Systems and methods for conveniently accessing, viewing, and transferring information stored in a variety of locations and associated with a variety of systems, devices, and applications are provided. A method may include receiving user account information; generating a user account using the user account information; receiving content source registration information; associating the user account and a content source using the content source registration information; receiving storage target registration information; associating the user account and a storage target using the storage target registration information; receiving a request to access content information related to the content source; receiving the content information in response to receiving the request to access the content information; and transmitting the content information to the storage target in response to receiving the content information.

### 1. FIELD

Systems, apparatuses, and methods consistent with example embodiments of the present disclosure relate to file transfer systems.

### 2. DESCRIPTION OF RELATED ART

Related art systems and methods used to transfer files between different operating systems, different software platforms, and different devices have proven arduous and time consuming. One particularly inconvenient related art method involves transferring a file from a system or device that is either disconnected from a wireless network (such as the Internet) or incapable of wireless communication altogether. Such system or device may be referred to as “offline.” In this case, a user may be required to (1) manually and physically connect a storage device, e.g., a flash memory drive or card, to the offline device, (2) facilitate storing one or more files in the storage device connected to the offline device, (3) manually and physically remove the storage device from the offline device, (4) travel to a computer that is connected to the wireless network (Intranet or Internet), and (5) manually and physically connect the storage device to the computer, (6) install or access a file-transfer software application on the computer, and (7) finally use the file-transfer software application to transfer the file to a desired location or device.

Even if a user's information or files are stored on a user's mobile device or in a cloud storage platform associated with a particular software application, existing systems and methods for accessing and transferring such information or files have also proven inconvenient and burdensome. Just as the number of mobile devices in modern society has increased significantly in recent years, unfortunately so too has the number of mobile applications (or “mobile apps”) stored on each user's mobile device. An major disadvantage of the increased number of mobile apps on a user's mobile device is the difficulty for the mobile device user to access, view, and transfer files or information associated with each of the many mobile apps.

Accordingly, related art systems have failed to give users the ability to easily access, view, and transfer information stored in a variety of locations and associated with a variety of systems, devices, and applications. It is thus desired to address the above-mentioned disadvantages and shortcomings of the existing systems and methods and provide seamless and manageable file transfer techniques that decrease the above-noted burden on users.

### SUMMARY

Accordingly, systems and methods for conveniently accessing, viewing, and transferring information stored in a variety of locations and associated with a variety of systems, devices, and applications are provided. In one embodiment, a method may include receiving user account information; generating a user account using the user account information; receiving content source registration information; associating the user account and a content source using the content source registration information; receiving storage target registration information; associating the user account and a storage target using the storage target registration information; receiving a request to access content information related to the content source; receiving the content information in response to receiving the request to access the content information; and transmitting the content information to the storage target in response to receiving the content information.

The method may further include communicating with an application programming interface in response to receiving the request to access the content information. In the method, receiving the content information may include receiving the content information from the application programming interface.

In the method, receiving the request to access the content information related to the content source may include conducting a first transaction using a normalized communication protocol; communicating with the application programming interface in response to receiving the request to access the content information may include conducting a second transaction using a specialized communication protocol; receiving the content information related to the request may include conducting a third transaction using the specialized communication protocol; and transmitting the content information to the storage target in response to receiving the content information may include conducting a fourth transaction using the normalized communication protocol.

In the method, receiving the content source registration information may include receiving at least one content source input parameter used to communicate with a system connected to the content source; and receiving the storage target registration information may include receiving at least one storage target input parameter used to communicate with a system connected to the storage target.

The method may further include generating a plurality of content options using the content information in response to receiving the content information; and displaying, on an electronic device associated with the user account, the plurality of content options in response to generating the plurality of content options.

In the method, transmitting the content information to the storage target further may include transmitting the content information associated with a selected content option of the plurality of content options.

The method may further include determining whether the content source is connected to a wireless network; and upon determining the content source is connected to the wireless network, receiving the content information.

The method may further include determining whether the storage target is connected to a wireless network; and upon determining the storage target is connected to the wireless network, transmitting the content information to the storage target.

In the method, the content source may include at least one of a vehicle, a portable handheld video recording device, a digital single-lens reflex camera, or a cloud storage application.

In the method, the storage target may include at least one of vehicle, a portable handheld video recording device, a digital single-lens reflex camera, or a cloud storage application.

In yet another embodiment, a method may include receiving user account information; generating a user account using the user account information; receiving content source registration information relating to a plurality of content sources; associating the user account and the plurality of content sources using the content source registration information; receiving storage target registration information relating to a plurality of storage targets; associating the user account and the plurality of storage targets using the storage target registration information; receiving a request to access content information related to a selected content source of the plurality of content sources; receiving the content information in response to receiving the request to access the content information; receiving a request to transmit the content information to a selected storage target of the plurality of storage targets; and transmitting the content information to the selected storage target of the plurality of storage targets in response to receiving the request to transmit the content information related to the selected content source of the plurality of content sources to the selected storage target of the plurality of storage targets.

The method may further include communicating with an application programming interface in response to receiving the request to access the content information associated with the selected content source of the plurality of content sources. In the method, receiving the content information associated with the selected content source of the plurality of content sources may include receiving the content information associated with the selected content source of the plurality of content sources from the application programming interface.

In the method, receiving the request to access the content information associated with a selected content source of the plurality of content sources may include conducting a first transaction using a normalized communication protocol; communicating with the application programming interface may include conducting a second transaction using a specialized communication protocol; receiving the content information associated with the selected content source of the plurality of content sources may include conducting a third transaction using the specialized communication protocol; and transmitting the content information associated with the selected content source of the plurality of content sources to the selected storage target of the plurality of storage targets may include conducting a fourth transaction using the normalized communication protocol.

In the method, receiving the content source registration information may include receiving at least one content source input parameter used to communicate with a system connected to the content source; and receiving the storage target registration information may include receiving at least one storage target input parameter used to communicate with a system connected to the storage target.

The method may further include generating a plurality of content options using the content information associated with the selected content source of the plurality of content sources in response to receiving the content information associated with the selected content source of the plurality of content sources; and displaying, on an electronic device associated with the user account, the plurality of content options in response to generating the plurality of content options.

In the method, at least one content source of the plurality of the content sources may be the same as at least one source target of the plurality of source targets.

The method may further include determining, for each content source of the plurality of content sources, a content source connection status related to whether each content source of the plurality of content sources is connected to a wireless network; and displaying, on an electronic device associated with the user account, the content source connection status of each content source of the plurality of content sources.

The method may further include determining, for each storage target of the plurality of storage targets, a storage target connection status related to whether each storage target of the plurality of storage targets is connected to a wireless network; and displaying, on an electronic device associated with the user account, the storage target connection status of each storage target of the plurality of storage targets.

In the method, at least one content source of the plurality of content sources or at least one storage target of the plurality of storage targets may include at least one of a vehicle, a portable handheld video recording device, a digital single-lens reflex camera, or a cloud storage application.

In yet another embodiment, a non-transitory computer-readable medium may store computer readable program code or instructions for carrying out operations, which when executed by a processor perform operations that may include receiving user account information; generating a user account using the user account information; receiving content source registration information; associating the user account and a content source using the content source registration information; receiving storage target registration information; associating the user account and a storage target using the storage target registration information; receiving a request to access content information related to the content source; receiving the content information in response to receiving the request to access the content information; and transmitting the content information to the storage target in response to receiving the content information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a multi-step process of transferring a video file captured by a vehicle camera system through the user of a portable storage device and a laptop computer, in accordance with a related art system.

FIG. 2 is a diagram illustrating a super application and possible functions that may be performed by the super application, in accordance with one or more example embodiments;

FIG. 3 shows exemplary displays of a mobile device involved in the sending of one or more files from a content source to a storage target, in accordance with one or more example embodiments;

FIG. 4 is a diagram illustrating a super application that may employ techniques in accordance with one or more example embodiments;

FIG. 5 is a diagram illustrating a multitude of devices, systems, or applications connected to a super application in accordance with one or more example embodiments;

FIG. 6 is a diagram illustrating systems with user devices in accordance with one or more example embodiments;

FIG. 7 illustrates a flowchart of a method for conveniently accessing, viewing, and transferring information stored in a variety of locations and associated with a variety of systems, devices, and applications, in accordance with one or more example embodiments, in accordance with one or more example embodiments;

FIG. 8 is a diagram of an example environment in which systems and/or methods, described herein, may be implemented; and

FIG. 9 illustrates a diagram of components of one or more devices, in accordance with one or more example embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide systems and methods for easy access and transfer of files from any source device/location to any target device/location.

As noted above, existing methods of transferring files from a variety of devices suffer from major disadvantages. One existing method relates to the transfer of a file (e.g., an image or video file) from a camera connected to or integrated into a vehicle (“vehicle camera”). Users wishing to transfer files from such devices must perform an inconvenient multi-step process.

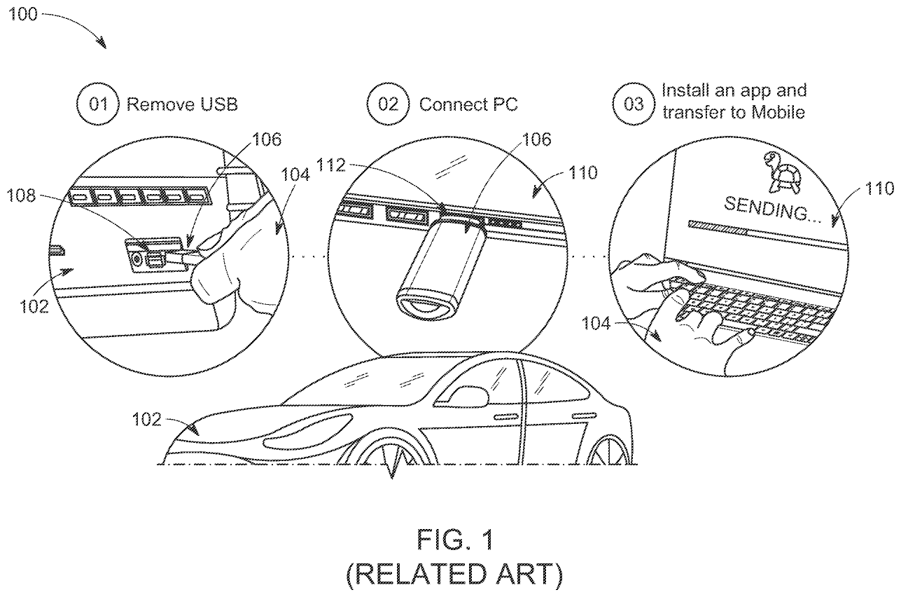

FIG. 1 illustrates a related art file transfer process 100 in which the source of the file is a vehicle 102, and the file is a video file captured by a vehicle camera system. The camera (not shown) of the vehicle camera system may be a rear view camera, a dashboard camera, a windshield-mounted camera, a fender- or bumper-mounted camera, a side-mirror-mounted camera, or any other vehicle camera. The vehicle camera system may be incorporated into the vehicle 102 itself, e.g., included in the vehicle 102 as produced by the manufacturer. Alternatively, the vehicle camera system may be a separate system connected to the vehicle 102, such as, e.g., an “after-market” dashboard camera system.

The process 100 begins with a user 104 having to insert a portable storage device 106 (e.g., a USB drive or other type of portable memory card, stick, or drive), into a slot or port 108 of the vehicle 102. In the configuration shown in FIG. 1, the port 108 is included in the interior (e.g., in a compartment of a center console, in a glovebox, etc.) of the vehicle 102. The type of portable storage device 106 used may depend on the type of slot or port 108 included in the source device, which in this instance is the vehicle 104.

Next in the process 100, the user 104 is required to save the file(s) onto the portable storage device 106. In one embodiment, the user 104 saves files onto the portable storage device 106 by selecting one or more files shown on a display screen (not shown) of the vehicle 102. After saving one or more files onto the portable storage device 106, the user 104 physically removes the portable storage device 106 from the port 108 of the vehicle 102. The user 104 then travels with the portable storage device 106 to the location of a computer 110, e.g., a laptop or desktop. The user 104 physically connects the portable storage device 106 to the computer 110 via a slot or port 112 of the computer 110.

The process shown in FIG. 1 may become further complicated and burdensome if the port 108 of the source device (e.g., vehicle 102) and the port 112 of the computer 110 do not have a common communication interface. For example, if the port 108 of the vehicle 102 is a USB port and all of the ports of the computer 110 are USB-C ports, the user 104 may be incapable of transferring files without a USB-C to USB adapter (not shown). Therefore, when the port 108 of the source device 102 is different from the port 112 of the computer 110, the user 104 may be required to purchase and have an additional component, e.g., an adapter (not shown), to transfer files to the computer 110.

While USB and USB-C are two exemplary communication interfaces, the communication interface used by source device 102 and the computer 110 are not limited thereto. Instead of a flash or USB drive, the portable storage device 106 may be a memory stick or memory card. Also, the communication interface technology used by the source device 102, the computer 110, or the portable storage device 106 may include, e.g., Secure Digital (SD, miniSD, microSD), Memory Stick (MS), MultiMediaCard (MMC), SmartMedia (SM), XD-Picture Card (xD), Subscriber Identity Module (SIM), or any other flash memory or solid state drive technology.

Only after the user 102 physically connects the portable storage device 104 to the computer 110 can the user 102 check the files, view the content of the files, and transfer the files. To transfer the files, the user 102 may be required to install or access a file transfer application on the computer 108. Therefore, additional obstacles, i.e., the installing of the one or more file transfer applications, may hinder the ability of the user 102 to transfer the files from the computer 108 to another location, e.g., a mobile device of interest.

While the process 100 of FIG. 1 is shown with respect to a vehicle 102, the same inconvenient multi-step process 100 may also be required when users transfers files from other source devices, e.g., action cameras, digital cameras (e.g., single-lens reflex camera (DSLR) cameras), and other user devices or sensors that are configured to record or capture data.

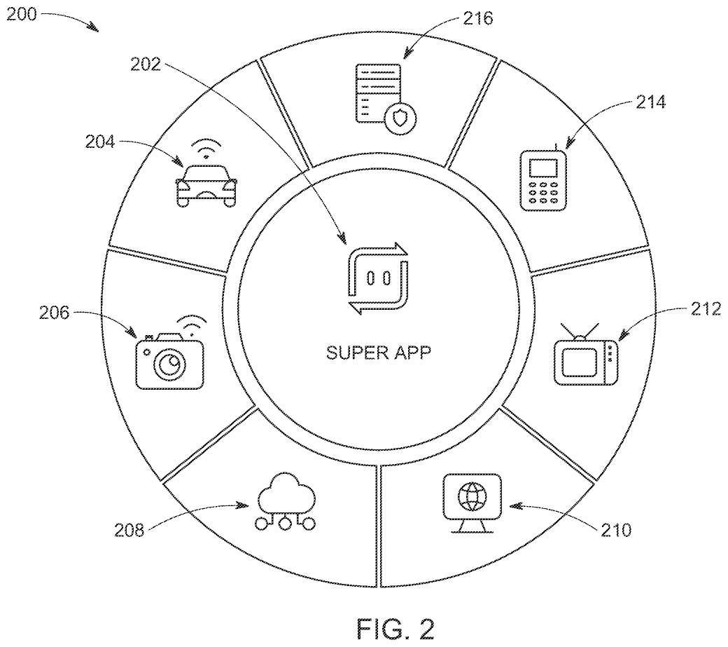

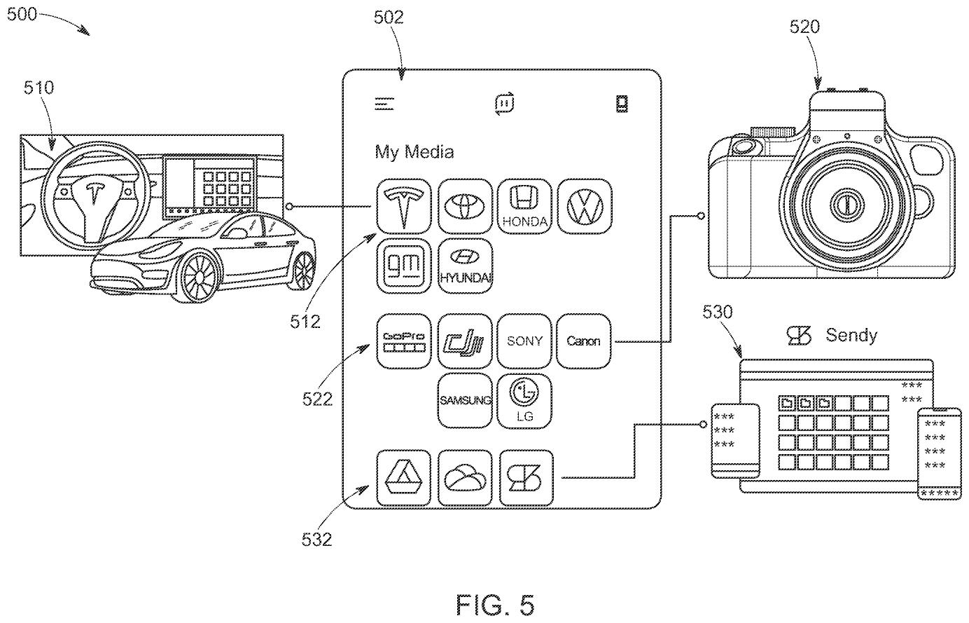

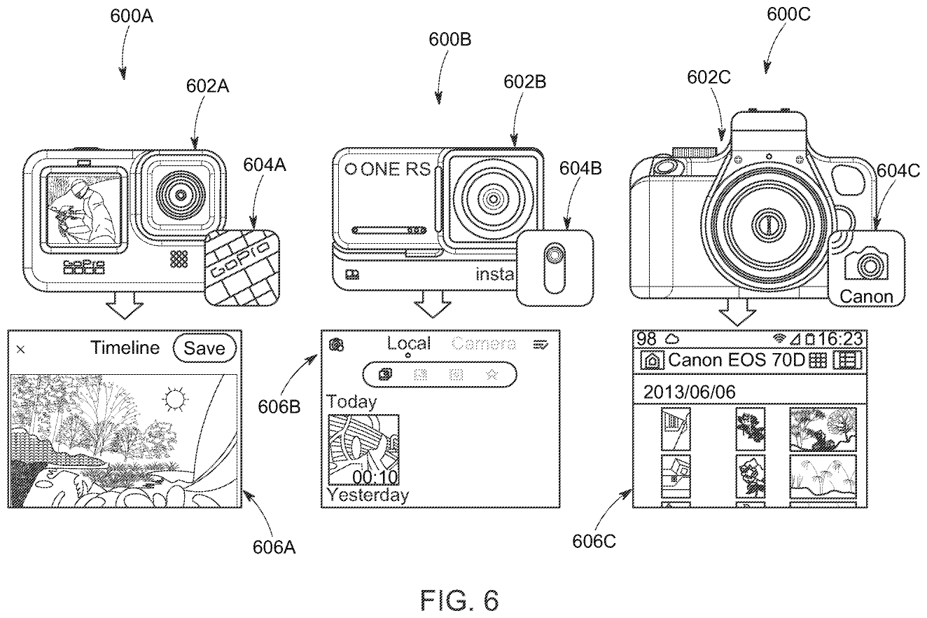

FIG. 2 is a block diagram of a super application 202, which is part of a super application system 200 that may be used to solve the above noted problems of the related art systems. The super application system 200 provides for conveniently accessing, viewing, and transferring information stored in a variety of locations and associated with a variety of systems, devices, and applications. The super application 202 may include a central application 202 that controls the functionality of a plurality of user devices, e.g., user devices further discussed below with reference to FIGS. 5 and 6, via interaction with a plurality of connected devices or connected systems, e.g., connected device/system 204, 206, 208, 210, 212, 214, and 216.

Each of connected device/system 204, 206, 208, 210, 212, 214, and 216 may be either a connected device or a connected system. While the connected device/system 204, 206, 208, 210, 212, 214, and 216 are referred to as being “connected,” in one embodiment, one or more of connected device/system 204, 206, 208, 210, 212, 214, and 216 may be offline or otherwise disconnected from the Internet or other wireless communication network, e.g., an Intranet of an organization. According embodiments of the present application, the system 200 may facilitate obtaining information from and/or transmitting information to one or more of the connected device/systems 204, 206, 208, 210, 212, 214, and 216; and the super application 202 may be a central resource that one or more end users may access to execute such functions.

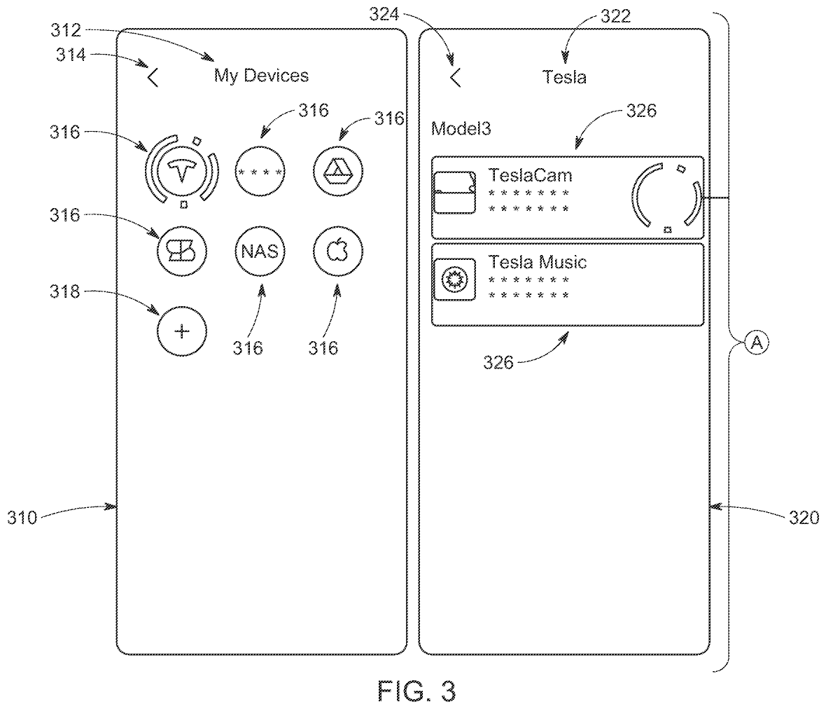

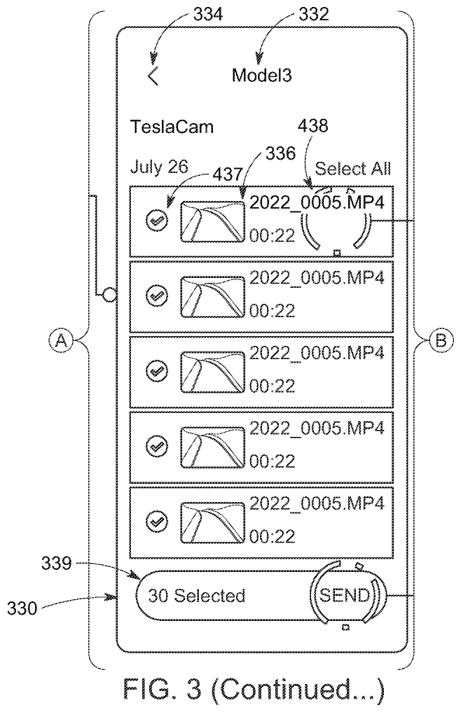

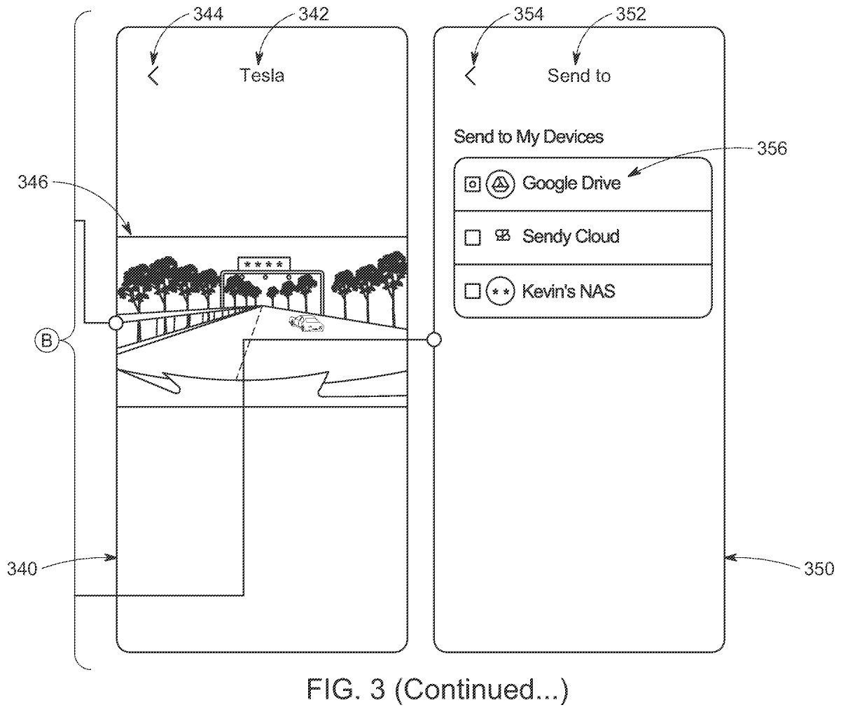

In one embodiment, the connected device/system 204 may be a connected vehicle. As further discussed below with reference to FIGS. 3-5, the connected vehicle may be coupled to one or more cameras (not shown) that record video, e.g., of a vehicle's surroundings. While one or more cameras may be one type of device coupled to the connected vehicle, the type of device is not limited thereto. In addition or in the alternative, the connected vehicle may record data from other types of sensors including but not limited to one or more radar sensor(s), lidar sensor(s), scanner(s), optical sensor(s), ultrasonic sensor(s), motion detector(s), proximity detector(s), audio sensor(s) (e.g., microphone(s)), temperature sensor(s), and light ray detector(s). Such sensor(s) may be used to capture data regarding surroundings exterior to the vehicle, data regarding the interior of the vehicle (e.g., activity inside the vehicle's cabin), or data regarding the motor or other portions of the vehicle's propulsion or breaking system(s).

Additional exemplary sensor types may include sensors used to determine a multitude of conditions of the vehicle including but not limited to traveling conditions and vehicle health conditions. For example, the data may relate to data obtained from, e.g., one or more battery sensor(s), air-flow sensor(s), engine knock sensor(s), engine speed sensor(s), break sensor(s), break pedal sensor(s), seatbelt sensor(s), seat sensor(s), steering wheel sensor(s), camshaft position sensor(s), RPM sensor(s), torque sensor(s), Manifold Absolute Pressure (MAP) sensor(s), Mass Air Flow (MAF) sensor(s), throttle position sensor(s), voltage sensor(s), current sensor(s), impedance sensors(s), oxygen sensor(s), NOx sensor(s), fuel sensor(s), speed sensor(s), acceleration sensor(s) (e.g., accelerometer(s)), parking sensor(s), rain sensor(s), compass(es), orientation sensor(s) (e.g., gyroscope(s)), position sensor(s), satellite navigation system sensor(s), or any other sensor(s) or data capture device(s) now known or to be developed. Accordingly, the super application 202 may communicate with the connected device/system 204, which may relate to a connected vehicle, and obtain any data from the connected device/system 204 captured by any of the above-noted sensor(s) at any time.

The connected vehicle may be gasoline-powered, diesel-powered, a hybrid, a fully electric vehicle, partially autonomous, or fully autonomous. The connected vehicle may be, e.g., a bicycle, motorcycle, car, SUV, van, or any type of truck. In one embodiment, the connected vehicle is an autonomous semi-trailer truck, which may be a part of a fleet of autonomous semi-trailer trucks. In addition to or instead of a land vehicle, the connected vehicle may be a jet-ski, boat, helicopter, plane, jet, rocket, any type of manned or unmanned vessel, or a combination of such. For example, the connected vehicle may be an “amphibious” vehicle configured to travel on land and above and/or under water, a seaplane configured for air-travel and water landings/takeoffs, etc. Accordingly, additional or alternate sensors integrated into or attached to the connected vehicle may include but are not limited to altitude sensor(s), pressure sensor(s), linear variable differential transformer (LVDT) sensor(s), force sensor(s), vibration sensor(s), rudder sensor(s), level sensor(s), thrust sensor(s), stabilizer fin sensor(s), wind sensor(s), etc.

The connected device/system 206 may be, e.g., an action camera, a digital camera (e.g., a single-lens reflex camera (DSLR) camera), or device or sensor configured to record or capture data. In the alternative, the connected device/system 206 may be, e.g., a drone device. The drone device may be a small- or large-scale flying device. The drone device may have one or more propellers used to control flight or aid in flight of the drone device, or the drone device may be jet-powered. The drone device may have one or more cameras and/or other sensors, such as the sensors noted above with respect to the connected device/system 204. The camera(s), sensor(s), and/or flight system(s) of the drone device may be controlled by a person (e.g., a user), or they may be partially or fully autonomous.

The connected device/system 208 may be a memory storage system, repository, or database such as, e.g., a cloud storage system/repository/database. The connected device/system 210 may be a connected computer, e.g., laptop, desktop, or tablet computer. The connected device/system 212 may be a television, e.g., a smart television device/system. The connected device/system 214 may be a cell phone, telephone, smartphone, wearable device, smart headphones, or other smart portable electronic device; and the connected device/system 216 may be one or more security devices or security systems. In one embodiment, the connected device/system 216 is a home security system that includes one or more security cameras, motion detectors, automatic light or spotlight systems, etc. The home security system may monitor activity inside a user's home, outside a user's home, or both. In addition to or in the alternative to a home, the security system may serve to monitor or surveille the interior or exterior premises of a business, church, school, government organization, non-profit organization, or any other organization.

While the connected devices/systems 204, 206, 208, 210, 212, 214, and 216 are described as being distinct devices, in some embodiments, the one or more of the connected devices/systems 204, 206, 208, 210, 212, 214, and 216 are combined into one or more combined connected devices/systems. Moreover, any of the connected devices/systems 204, 206, 208, 210, 212, 214, and 216 may include any of the aforementioned sensors or data capture devices, and therefore the sensors and/or data capture devices that may be included in any of the connected devices/systems 204, 206, 208, 210, 212, 214, and 216 is not limited.

Also, while FIG. 2 illustrates one connected device/system 204, one connected device/system 206, one connected device/system 208, one connected device/system 210, one connected device/system 212, one connected device/system 214, and one connected device/system 216, the system 200 may include any number of each of the connected devices/systems 204, 206, 208, 210, 212, 214, and 216. Furthermore, if there are two or more of one particular type of connected device/system, e.g., two connected vehicles, these two connected vehicles may be different, e.g., in terms of what company makes the vehicle, what cameras/sensors are included in the vehicle, etc. The connected devices/systems 204, 206, 208, 210, 212, 214, and 216 are not limited to the aforementioned connected devices/systems 204, 206, 208, 210, 212, 214, and 216, and may include other connected devices/systems 204, 206, 208, 210, 212, 214, and 216 not expressly noted above. Accordingly, the amount as well as the types of connected devices/systems 204, 206, 208, 210, 212, 214, and 216 compatible with the super application system 200 is not limited.

In one embodiment, if one or more of the devices/systems 204, 206, 208, 210, 212, 214, and 216 are in close proximity and/or connected to the same network (e.g., Wi-Fi network or other Local Area Network (LAN)). In this case, the network-connected and/or proximate devices/systems 204, 206, 208, 210, 212, 214, and 216 may use the super application 202 to share sensors or computing resources, or combine sensors or computing resources, to perform or support additional features or functions that may be otherwise unavailable to the devices/systems 204, 206, 208, 210, 212, 214, and 216 functioning alone.

In any case, data may be captured by any device or sensor associated with one or more of the connected devices/systems 204, 206, 208, 210, 212, 214, and 216. This data may be stored in one or more memory storage locations associated with the corresponding connected device/system 204, 206, 208, 210, 212, 214, and 216. Such memory storage locations may be attached to or integrated with the connected device/system 204, 206, 208, 210, 212, 214, and 216 itself. The super application 202 may be configured to selectively communicate with one or more of the connected devices/systems 204, 206, 208, 210, 212, 214, and 216 in order to access, manage, or transfer the data stored in the aforementioned memory storage locations. As such, the data accessed, managed, or transferred may be data recorded or captured at any point in the past. Additionally or in the alternative, any one or more of the connected devices/systems 204, 206, 208, 210, 212, 214, and 216 may be configured to capture or record data in real time, and the super application 202 may be configured to facilitate the instantaneous or near instantaneous access, management, and transfer of any such real time data.

Not only is the super application 202 configured to communicate with any of the one or more of the connected devices/systems 204, 206, 208, 210, 212, 214, and 216 to obtain data (e.g., video, audio, and/or images files) therefrom, the super application 202 may also be configured to transfer data (e.g., video, audio, and/or images files) to such devices. Furthermore, the system 200 may be configured such that one or more users can access the super application 202 from a multitude of devices. In one embodiment, the system 200 is configured such that the super application 202 may be accessed from one or more of the connected devices/systems 204, 206, 208, 210, 212, 214, and 216; and in yet another embodiment, system 200 is configured such that the super application 202 may be accessed from every one of the connected devices/systems 204, 206, 208, 210, 212, 214, and 216. As such, any or all of the connected devices/systems 204, 206, 208, 210, 212, 214, and 216 may be used to upload, download, access, manage, and transfer files to and from the connected devices/systems 204, 206, 208, 210, 212, 214, and 216, as well as other connected devices/systems.

The connected devices/systems 204, 206, 208, 210, 212, 214, and 216 may use different operating systems; may use different hardware, which includes the physical components that each electronic device/system requires to function; and may run on or function using different software platforms, e.g., different technology platforms, computing platforms, utility platforms, interaction networks, marketplaces, on-demand service platforms, content crowdsourcing platforms, data harvesting platforms, and/or content distribution platforms. The super application system 200 is configured to provide a seamless user interface by which a user of the super application system 200 may effortlessly manage data stored in a variety of devices, systems, and locations. By accessing the super application 202, the user is no longer required to interact individually with each of the connected devices/systems 204, 206, 208, 210, 212, 214, and 216 to access, manage, and transfer data associated with that particular connected device/system 204, 206, 208, 210, 212, 214, and 216.

FIG. 3 illustrates an exemplary process of transferring a file from a first device, system, or location (e.g., one of the connected devices/systems 204, 206, 208, 210, 212, 214, and 216) to another device, system, or location (e.g., another one of the connected devices/systems 204, 206, 208, 210, 212, 214, and 216). In one embodiment, a user may interact with a mobile device thereby accessing the super application 202 on the mobile device. As noted above, while a user may access the super application from a variety of devices, the embodiment shown in FIG. 3 shows one series of exemplary displays 310, 320, 330, 340, and 350, which may be, e.g., screenshots of a user's screen while accessing the super application 202 on a mobile device. The first display 310 displays a title 312, a back button 314, a plurality of icons 316 that correspond to content sources that have been registered to the user's account, and an icon 318 used to register an additional content source to the user's account. In this embodiment, the title 312 reads “My Devices.” In one embodiment, the title is customizable by the user and may be changed to a user-chosen title. The back button 314 may return the user to a previous page, direct the user to a home page, or log the user out of his or her account.

In one embodiment, before the user interface of the super application 200 shows the first display 310 or the like, a user may be required to create an account, register content sources, or both. A user may create an account by entering a unique user name and password. The super application 200 may require the password to meet certain criteria. For example, a proposed password may not be accepted if the proposed password is less than a predetermined number of characters. Additionally, upon entering a unique username and acceptable password, the user may further be required to verify his or her account. Account verification may include prompting the user to provide an email address or telephone number. After the super application 200 receives the email address or telephone number via the user interface, the super application 200 may then send a code to the received email address or telephone number. The super application 200 may then prompt the user to enter the code via the user interface. If the super application 200 receives via the user interface a code matching the code sent to the user's email address or telephone number, the super application 200 may thereby verify the user's account. Of course, the above-noted registration/verification process may include encryption and decryption of data and/or additional or alternative security measures. In this regard, the aforementioned account creation and/or verification process may include, e.g., using one or more cryptographic hash functions in the storing of user data and/or in sending and receiving information.

After creating a user account, the super application 200 may provide a method for adding or registering one or more content sources and/or one or more storage targets. A content source is generally a device, system, or location with which the super application 200 may communicate and obtain content information therefrom. Conversely, a storage target is generally a device, system, or location with which the super application 200 may communicate and transfer content information thereto. In one embodiment, an added content source may also be added as a storage target. An added storage target may also be added as a content source. Possible content sources and possible storage targets may be any one or more of the connected devices/systems 204, 206, 208, 210, 212, 214, and 216.

Referring to FIG. 3, the plus icon 318 is one exemplary user interface element that may be interacted with to add or register a content source or a storage target. As noted, the plurality of icons 316 correspond to content sources that have been registered to the user's account. Via the super application 202, a user may be able to communicate with the content source to obtain data therefrom, and send the data to a storage target. FIG. 3 shows six content source icons 316 that correspond to six registered content sources. The registered content sources may relate to one or more connected vehicles (e.g., a Tesla vehicle), action cameras (e.g., a GoPro), cloud storage applications (e.g., an account of Google Drive, Dropbox, Microsoft OneDrive), file transfer applications (e.g., Sendy), or any other device, system, or application.

In FIG. 3, a user may interact with his or her mobile device to, e.g., indicate a selection of one of the plurality of content source icons 316. As shown, the user selects the first content source icon 316, which corresponds to a registered Tesla vehicle. Upon selecting this first content source icon 316, the super application 202 may display a second display 320. The second display 320 includes a title 322, a back button 324, and one or more content source categories 326 corresponding to the content source associated with the selected content source icon 316. The back button 324 may allow a user to return to the first display 310. The title 322 may or may not be entered by a user, e.g., at the time a content source is registered; and in the exemplary embodiment shown in FIG. 3, the title 322 is “Tesla.” In one embodiment, there may be multiple content sources associated with a content source category. In the embodiment shown in FIG. 3, there is only one content source, which is named “Model3,” and may correspond to a Tesla Model 3 owned by the user, but if the user either owns multiple Tesla vehicles or registers multiple tesla vehicles, e.g., one that he owns and another that his or her family member owns, there may be more than one content source shown in the second display 320.

The content source categories 326 may relate to types of data captured by the content source or types of files stored in a memory associated with the content source. FIG. 3 shows two content source categories 326. The first content source category 326 is titled “TeslaCam” and relates to, e.g., image or video data captured by one or more cameras attached to or integrated into the content source (e.g., the user's Tesla Model 3). The second content source category 326 is titled “Tesla Music” and may relate to music files stored in a memory of the content source or music stored in a memory associated with the content source. If a user were to select the second content source category 326 titled “Tesla Music,” the user may be directed to a repository of music files that the user may send to another device, system, location, or user. While two exemplary content source categories the image or video data captured content source category and the stored music content source category, the content source categories are not limited thereto and may relate to a variety of data or files associated with any number of devices, systems, programs, or applications. The second display 320 may show information relating to each of the content source categories 326. For example, the second display 320 may indicate a last update date, a number of files, and an amount of data (e.g., in kilobytes, megabytes, gigabytes, or terabytes, etc.) associated with each of the content source categories 326. The user may interact with his or her mobile device to, e.g., indicate a selection of one or more of the plurality of content source categories 326 to advance to a next screen that enables viewing and/or sending of files associated with the selected content source category or categories 326. In the embodiment shown in FIG. 3, the user may indicate a selection of the first content source category 326 named “TeslaCam,” and the super application 202 may respond by displaying the third display 330.

The third display 330 may display a title 332, a back button 334, and one or more content source file representations 336 that each may represent a content source file. A user interacting with the back button 334 may cause the display to return to the second display 320. In one embodiment, the content source file representations 336 include one or more video files captured by one or more cameras attached to or integrated into a connected vehicle. The third display 330 may display a date associated with each of the content source file representations 336. In one embodiment, all of the video files below a displayed date correspond to videos captured on that displayed date. In the third display 330 shown in FIG. 3, there are five content source file representations 336 shown, but there may be additional content source file representations 336 in addition to the five shown, and these additional content source file representations 336 may be accessed by scrolling down, e.g., by a user touching the screen of the mobile device and performing a swipe up gesture in which the user drags his or her finger upward on the screen while maintaining contact with the screen.

Each of the content source file representations 336 may have a corresponding selector icon 337. The user may select one or more of the selector icons 337 corresponding to each content source file representation 336. In one embodiment, the selector icon 337 may be either in a non-selected state or in a selected state. The selector icon 337 may toggle between the non-selected state and the selected state based on user input. For example, if the user is using a touch screen mobile device, the user may tap on the selector icon 337 to toggle the selector icon state, which may be referred to as selecting the selector icon 337. Of course, a similar clicking may be performed by a user using a mouse, trackpad, or other input device if the user is accessing the super application 202 on a desktop or laptop computer. In one embodiment, the selected state of the selector icon 337 may be represented with a graphic including a circle that includes a check mark within the circle, and the non-selected state of the selector icon 337 may be represented with a graphic including a circle that does not include a check mark within the circle. However, the selected and non-selected states of the selector icon 337 may be represented with any graphic or indication of a selected and non-selected state and is not limited to any particular graphic or indication. The display 330 may further include a file name for each of the content source file representations 336. If the content source file representations 336 are video or audio files, the display 330 may further include an indication of the duration of the video or audio file corresponding to the content source file representations 336. For example, there may be an indication of the amount of minutes and seconds corresponding to each video or audio file of the content source file representations 336. If the video or audio file lasts an hour or longer, the indication of the duration of the video or audio file may also include how many hours the video or audio file lasts.

The display 330 may also include a way for a user to select all of the content source file representations 336 associated with the one or more selected content source categories 326. For example, the display 330 may display a “select all” button, which when selected by the user causes every selector icon 337 (corresponding to every content source file representation 336 associated with the one or more selected content source categories 326) that is in the non-selected state to change to selected state. If one or more selector icons 337 were already in the selected state when the “select all” is selected, such selector icons 337 remain in the selected state. If all of the selector icons 337 are in the selected state when the user interacts with the “select all” button, all of the selector icons 337 may revert back to the non-selected state. In one embodiment, when all of the selector icons 337 are in the selected state, the “select all” button may change appearance to instead read “de-select all.” Therefore, the “select all” button, which may circumstantially change to a “de-select all” button may be used to either select every, or de-select every, every content source file representation 336 associated with the one or more selected content source categories 326. Of course, “select all” and “de-select all” are not necessarily displayed on the third display 330, and any indication or graphic may be displayed for the “select all” button (and/or “de-select all” button).

The super application 202 may enable a user to view the contents of a file corresponding to a content source file representation 336. For example, the super application 202 may allow a user to interact with one of the content source file representations 336 to thereby view the contents of the file associated with the content source file representation 336. In one embodiment, a user may tap or click on a file name or title 338 of a content source file representation 336. For example, a user may click the file name 338 of the first displayed content source file representation 336 shown in the third display 330, and the super application 202 may respond by displaying the fourth display 340. The fourth display 340 may include, e.g., a title 342, a back button 344, and a file display 346. The title 342 may be any title and may be associated with the contents displayed in the file display 346. The file display 346 may display the contents of the file associated with the selected content source file representations 336, which in this instance is the first displayed content source file representation 336 shown in the third display 330.

In one embodiment, a user may perform a circle gesture on the third display 330, e.g., by placing his or her finger on the touch screen and drawing a circle around a plurality of content source file representations 336. The encircled content source file representations may be selected such that the fourth display 340 may be used to sequentially or simultaneously view file contents of multiple content source file representations. In one embodiment, the super application 202 may provide a way for the user to change between viewing the file contents of source file representations 336. For example, a user may interact with the mobile device display by performing a swipe gesture, e.g., either swiping from left to right or swiping from right to left on the display 340 to change between viewing the file contents of different source file representations 336. In one embodiment, swiping on the screen proceeds to the next chronological file shown in the third display 330. The manner in which the super application 202 allows a user to change between each of the multiple files corresponding to the multiple selected content source file representations 336 is not limited to a swipe gesture, and any way of changing between file contents of content source file representations 336 may be used or implemented.

Upon a user clicking a particular file from the third display 330, the contents of the file may be automatically displayed on the fourth display 340. If the selected file is an audio or video file, the audio or video file may automatically play upon a user navigating to the fourth display 340. A user may interact with the back button 344 to return to the third display 330, which may again display one or more content source file representations 336 corresponding to a particular content source category 326 of a particular content source icon 316.

When viewing the third display 330, if a user toggles one more selector icons 337 to the selected state, either by individually interacting with one or more selector icons 337 or interacting with the “select all” button, the display 330 may display a send feature 338. The send feature 339 may indicate the number of files “selected,” i.e., a number of content source file representation 336 having selector icons 337 in the selected state. The send feature 339 may further include a send button. The user may interact with his or her mobile device to select the send button, and upon selecting the send button, the super application 202 may respond by displaying the fifth display 350.

The fifth display 350 may display a title 352, a back button 354, and one or more storage target representations 356. In one embodiment, the storage target representations 356 correspond to previously added or previously registered storage targets. While not shown in FIG. 3, the fifth display 350 may include a button to add or register one or more storage targets. As noted, a storage target may be a device, system, application, or location to which information, data, or files may be sent and/or delivered. In one embodiment, one or more of the added or registered content sources (e.g., corresponding to the content source icons 316) are automatically added or registered as storage targets. In the embodiment shown in FIG. 3, there are three storage target representations 356. The first storage target representation 356 corresponds to a Google Drive, the second storage target representation 356 corresponds to a Sendy Cloud, and the third storage target representation 356 may be a Network Attached Storage (NAS) application associated with a particular person (e.g., the user himself/herself or another person). A user may select one or more of the displayed storage target representations 356 to thereby send the files corresponding to the files selected when interacting with third display 330. While not shown in the fifth display 350, after a user selects one or more storage target representations 356, the fifth display 350 may further display a complete transfer button to complete the transfer of files to the selected storage target representation(s) 356. Upon clicking the complete transfer button, the files are then sent to the selected storage target representation(s) 356 and stored in one or more memories associated with the selected storage target representation(s) 356. As such, FIG. 3 shows exemplary displays of a mobile device involved in the sending of one or more files from a content source to a storage target, in accordance with one or more example embodiments.

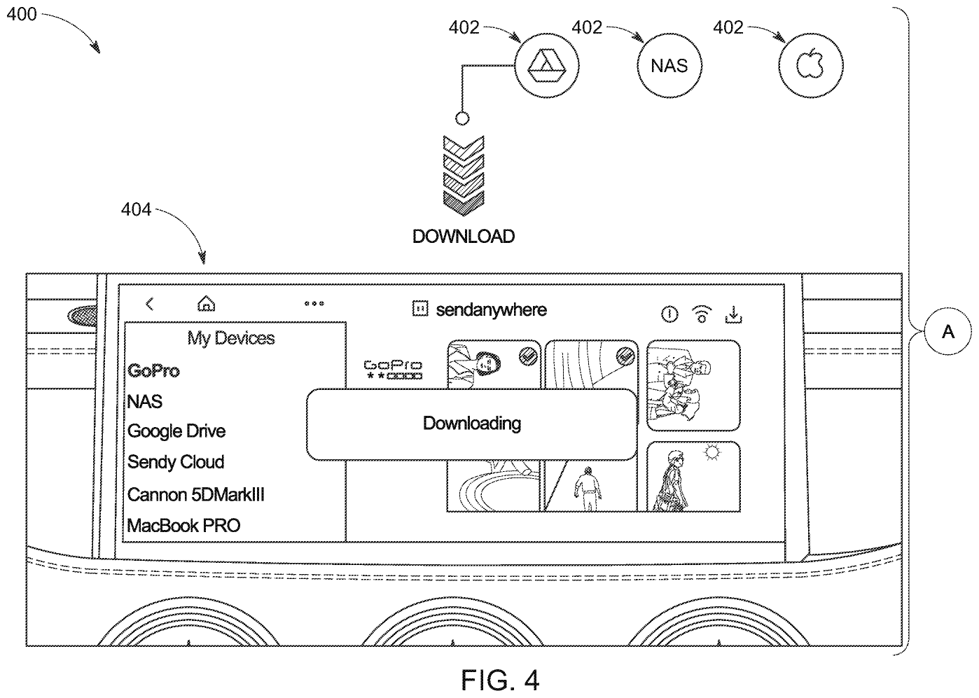

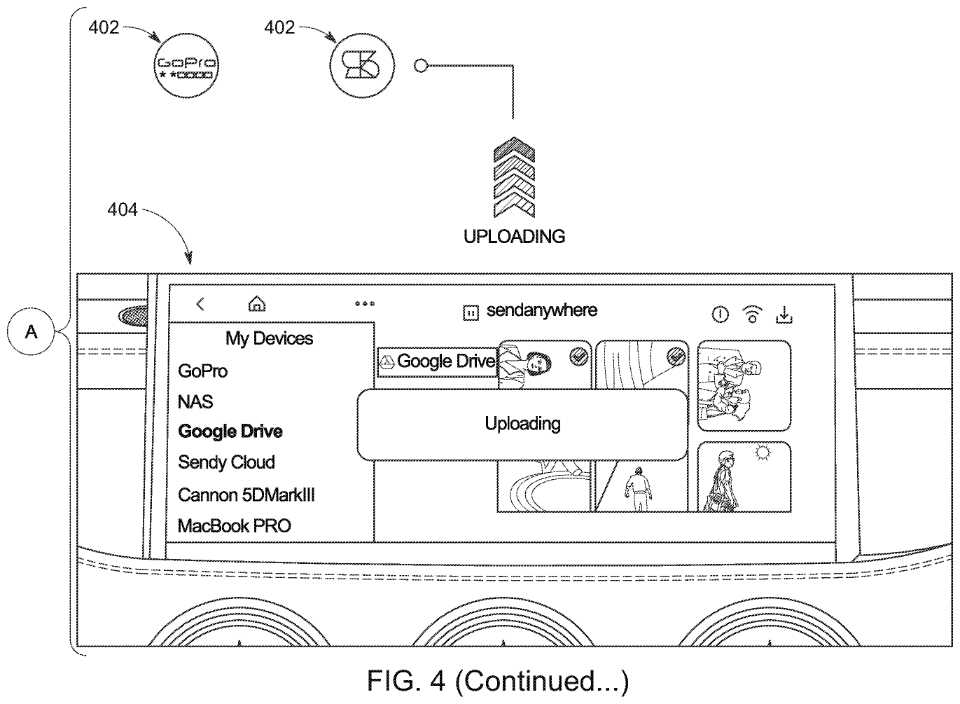

FIG. 4 shows an exemplary super application system 400 that may employ the techniques described herein. The system 400 may include processes or methods of interacting with one or more devices, systems, or applications 402, which may be devices, systems, or applications managed by, manufactured by, or produced by one or more third parties. The system 400 may also include a user device 404, which may serve as either or both of a content source device and/or a storage target device. When information, data, or files are downloaded to the user device 404, the user device 404 may be serving as a storage target device. Conversely, when information, data, or files are uploaded from the user device 404, the user device 404 may be serving as a content source device. In one embodiment, the user device 404 may be simultaneously serving as a contents source device and a storage target device. Therefore, the user device 404 may be simultaneously uploading and downloading information, data, or files.

In one embodiment, the one or more devices, systems, or applications 402 may include, e.g., one or more Google Drive accounts/applications; one or more NAS accounts/applications; one or more Apple devices/applications; one or more GoPro devices/applications; and one or more Sendy accounts/applications. The devices, systems, or applications 402 are not limited thereto and may include any connected device, system, or application including any device, system, or application that captures and/or stores information and may be connected to any number of sensors such as the sensors noted above with respect to the connected devices/systems 204, 206, 208, 210, 212, 214, and 216 or the like.

Each of the devices, systems, or applications 402 may operate using a variety of different operating systems, different software platforms, and different device hardware. Additionally, the user device 404 may have a different operating system, run using a different software platform, and have different device hardware and software components as compared to the devices, systems, or applications 402. The super application system 400 may be configured to use the super application 202 to connect such a multitude of different operating systems, different software platforms, and different device hardware to provide a seamless user experience in accessing, managing, and/or transferring files between a variety of user devices 404 and a variety of devices, systems, or applications 402. In this regard, the super application system 400 may be configured to selectively communicate using normalized communication data/protocols and specialized communication data/protocols.

In one embodiment, the user device 404 and/or the devices, systems, or applications 402 use one or more third party application programming interfaces (APIs). Such APIs may be “open” APIs, also known as public APIs. Open or public APIs are APIs that third party companies manage, but have provided ways for other companies or consumers to interact with the user device 404 or devices, systems, or applications 402. The open or public APIs may be, e.g., REST APIs or SOAP APIs or any other APIs that enable other companies or consumers to interact with the user device 404 or devices, systems, or applications 402. In one embodiment, the super application 202 may be downloaded on a number of user devices 404, which may be either or both of content source devices or storage target devices. The super application 202 may have an associated “back end” of the super application 202, which may relate to portions of the super application 202 (or program code associated with the super application 202) that allow the super application 202 to operate and that cannot be accessed by an end user or customer.

The super application 202 and associated back end may have separate software modules that communicate via a normalized communication protocol using normalized data. For example, when a user's mobile application has the super application 202 downloaded and installed thereon, the communication between the super application running on the user's mobile device and the super application back end may include the exchange of the normalized data, which may be exchanged using the normalized communication protocol.

In contrast, the super application may use specialized data and/or a specialized communication protocol when communicating with the devices, systems, or applications 402 and/or a user device 404, e.g., when the user device 404 is functioning as a content source or storage target. In one embodiment, the specialized communication protocol may consist of transmitting or receiving information corresponding to the specific open or public API that is used by the user device 404 or devices, systems, or applications 402. During registration of a content source and/or during registration of a storage target, the user device 404 or devices, systems, or applications 402 may provide the super application 202 with input parameters corresponding to the appropriate open or public API, and the super application 202 may configure the user's account such that future communications with the registered content source or storage target use the stored input parameters. In this regard, the super application 202 may be configured to not only communicate internally with normalized communication protocols and data, but the super application 202 may additionally be configured to operate with a number of the user device 404 or devices, systems, or applications 402, which provide for a convenient interface in communicating with any number of registered content source or registered storage targets.

As shown in FIG. 4, the user device 404 may be a connected vehicle, and the user may access the super application 202 via the display of the connected vehicle to download information, data, or files from any one or more of the devices, systems, or applications 402. In such instance, the connected vehicle would serve as the storage target, and the one or more of the devices, systems, or applications 402 would serve as a content source. Additionally, the user may use the connected vehicle, e.g., via interaction with a display of the connected vehicle, to upload information, data, or files from the connected vehicle to any one or more of the devices, systems, or applications 402. In that instance, the devices, systems, or applications 402 would serve as the storage target, and the one or more of the connected vehicle would serve as a content source. In either case, open or public APIs may be used to facilitate the communications to/from the connected vehicle and the super application 202 and/or to facilitate the communications to/from the devices, systems, or applications 402 and the super application 202.

FIG. 5 shows a multitude of devices, systems, or applications connected to the super application 202 as media capable of being used in a super application system 500 in a number of ways. The super application system 500, e.g., includes a connected vehicle 510, a connected camera 520, and a connected application 530, which may be, e.g., a Sendy application. There may be a multitude of additional connected devices, systems, or applications (not shown), and the connected vehicle 510, connected camera 520, and connected application 530 are shown for illustrative purposes. Each of the connected vehicle 510, connected camera 520, and connected application 530, as well as the additional connected devices, systems, or applications may interface with the super application 202. In one embodiment, when the super application 202 is accessed by a user on a user's mobile device (or a display of a connected vehicle 510, a display of the connected camera 520, or any other computer or mobile device), the corresponding display may display the exemplary display 402 shown in FIG. 5. The display 502 may display, e.g., a plurality of icons corresponding to connected devices, systems, or applications, and such connected devices, systems, or applications may be either or both of content sources or storage targets. FIG. 5 specifically shows three groups of icons. The first group of icons include icons 512, which correspond to connected vehicles. Connected vehicles may include vehicles produced by Tesla, Toyota, Honda, Volkswagen, General Motors, and Hyundai, or any other vehicle manufacturer now known or later developed. The second group of icons includes icons 522, which correspond to devices such as action cameras, DSLRs, quadcopters, televisions, smart phones, wearable devices, or other devices or sensors configured to capture or record data. The icons 522 may include icons corresponding to devices produced by GoPro, Dji, Sony, Canon, Samsung, LG, and or any other device producer now known or later developed. The third group of icons includes icons 532, which correspond to, e.g., cloud storage applications. The cloud storage applications may be cloud storage applications made and/or managed by Google (e.g., Google Drive), Microsoft (e.g., Microsoft OneDrive), or Sendy.

When accessing the super application 202, e.g., when viewing display 502, the user may select one or more of the icons, e.g., one or more of the icons 512, 522, or 532, to either access information stored in the local memory of a particular device/application or access information stored in a memory associated with the particular device/application. In one embodiment, if a user intends to access information stored on a Canon camera 520, which has been previously registered with the user's account, the Canon icon 522 may be in color as opposed to in gray. In this instance, the user intends for the Canon camera 520 to be a content source. In one embodiment, the user may select the Canon icon 522, and the super application 202 may initiate a series of communications, which may occur in fractions of a second, e.g., 100 milliseconds or less to access information stored on the Canon camera 520. As such, the delay may be not be perceived by user, and the user may perceive clicking on the icon causes an instantaneous access of the contents of the desired content source.

First, upon receiving the input from the user, i.e., the user's selecting the Canon icon 522, the super application 202 may initiate a normalized communication exchange between the device the user is currently using (i.e., the device on which the user selected the Canon icon 522) and the super application back end. This first normalized communication causes the super application back end to initiate a specialized communication exchange between the super application back end and the actual device itself, which in this instance is the Canon camera 520. In another embodiment, the device the user is currently using (i.e., the device on which the user selected the Canon icon 522) may communicate directly with the Canon camera 520, e.g., if the Canon camera 520 is in proximity of the device the user is currently using (i.e., the device on which the user selected the Canon icon 522). In one embodiment, the device the user is currently using (i.e., the device on which the user selected the Canon icon 522) may be “aware” of any proximate devices, which have previously been registered as content sources.

The super application back end or the device the user is currently using (i.e., the device on which the user selected the Canon icon 522) may communicate with the Canon camera 520 using a specialized communication protocol, such as one that utilizes open APIs of the Canon camera 520. Upon communicating with the Canon camera 520 using the specialized communication protocol, the device the user is currently using (i.e., the device on which the user selected the Canon icon 522) may display the content information stored in the memory associated with the Canon camera 520 such that the user can access, manage, or transfer files from the Canon camera 520 anywhere as desired. A similar process may occur when accessing information, files, or data associated with one or more memories associated with the connected vehicle 510 and/or the connected application 530.

A similar process may occur when transmitting information to a storage target using the super application 202. For example, if a user wishes to send information, files, or data to the connected vehicle 510, after the user has selected which information, files, or data the user desires to send to the connected vehicle 510, the super application 202 may again initiate a normalized communication exchange between the device the user is currently using and the super application back end. This normalized communication causes the super application back end to initiate a specialized communication exchange between the super application back end and the storage target itself, which in this instance is the connected vehicle 510. In another embodiment, the device the user is currently using may communicate directly with the connected vehicle 510, e.g., if the connected vehicle 510 is in proximity of the device the user is currently using. In one embodiment, the device the user is currently using may also be “aware” of any proximate devices, which have previously been registered as storage target devices.

The super application back end or the device the user is currently using communicate with the connected vehicle 510 using a specialized communication protocol, such as one that utilizes open APIs of the connected vehicle 510. Upon communicating with the connected vehicle 510 using the specialized communication protocol, the connected vehicle 510 may receive the send information, files, or data from the content source such that the connected vehicle 510 may store such send information, files, or data. Thereafter, the user may again access the super application 202 from any device or computer to view, manage, and/or again transfer the send information, files, or data transmitted to the connected vehicle 510.

A similar process using the normalized and specialized communication protocols may be used to obtain information, files, or data from an application 530 (when the application 530 serves as a content source) and/or to send information, files, or data to the application 530 (when the application 530 serves as a storage target).

The icons shown in display 502 may be gray either because a device, product, or application corresponding to the gray icon has not yet been registered to the user's super application account or because the device, product, or application is unavailable for another reason. In one embodiment, a connected camera, e.g., connected camera 520 may be completely out of batteries and powered off. As such, the send anywhere application 202 is unable to access information stored on the connected camera 520 and/or unable to send information to the connected camera 520. In another embodiment, a connected vehicle 510, for example, may be underground in a parking garage or otherwise have an incredibly weak or absent connection. In such situations, the connected system, device, or application (e.g., connected camera 520 or connected vehicle 510) may be determined to be in an offline or disconnected state. When a connected system, device, or application is determined to ben in the offline or disconnected state, the super application 202 may cause the display 502 to show the icon corresponding to the offline/disconnected offline system, device, or application in a greyed-out appearance. In another embodiment, another indication of a system, device, or application being offline or disconnected may be used. For example, an “X” may be included on top of the icon(s) corresponding to the offline/disconnected offline system(s), device(s), or application(s), or any other indication of a system, device, or application being offline or disconnected may be used. In order to determine whether a system, device, or application is offline or disconnected, the super application system 500 may utilize one or more Packet Internet or Inter-Network Gropers (pings) or other automatic program(s) or method(s) to test and verify whether one or more particular systems, devices, or applications are connected or online. As such the system 500 may initiate, either periodically or selectively, communications with each of the registered content sources and/or storage targets to determine whether the registered content sources and/or storage targets are available for operation.

In one embodiment, a user may be able to add or register a new system, device, or application from the display 502. If a user selects a greyed out icon corresponding to a system, device, or application, and the user has not previously registered or added a system, device, or application of the product, system, device, or application corresponding to the selected grey icon, the super application 202 may prompt the user to perform a registration process of the selected system, device, or application.

FIG. 6 illustrates three systems 600A, 600B and 600C that each respectively includes user devices 602A, 602B, and 602C. The user devices 602A, 602B, and 602C may be may be video cameras, action cameras, digital cameras, DSLR cameras, or any other user device or sensor that captures or records data. In one embodiment, each of the devices 602A, 602B, and 602C may have a corresponding application 604A, 604B, and 604C. The corresponding application 604A, 604B, and 604C for example may be used to store information captured using the respective user devices 602A, 602B, and 602C. If a user accesses the applications 604A, 604B, and 604C, the user may see exemplary displays 606A, 606B, and 606C. In one embodiment, the send anywhere application 202 may be configured to use one or more specialized communication protocols to communicate with each application 604A, 604B, and 604C. Accordingly, the send anywhere application system may enable cross-platform, cross-operating system, and cross-device communications to initiate and perform the above-noted systems and methods of obtaining and sending information from a variety of devices. While in one embodiment, the send anywhere application 202 initiates communication directly with a device (e.g., user devices 602A, 602B, and 602C), in other embodiments, the send anywhere application 202 initiates communications with an application (e.g., corresponding application 604A, 604B, and 604C) corresponding to the device; and the application (e.g., application 604A, 604B, and 604C) may or may not communicate with the device (e.g., user devices 602A, 602B, and 602C) itself to facilitate the access, management, and transfer of information, files, or data originally captured by the device (e.g., user devices 602A, 602B, and 602C) itself.

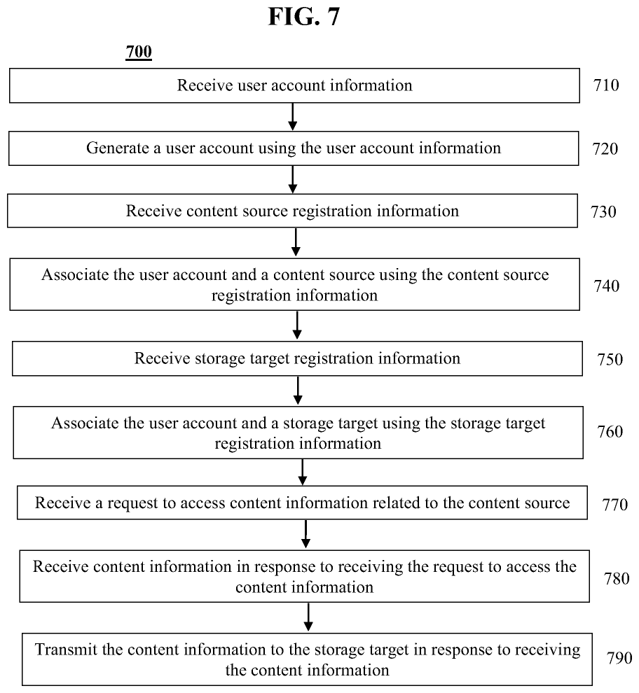

FIG. 7 illustrates a flowchart of a method for conveniently accessing, viewing, and transferring information stored in a variety of locations and associated with a variety of systems, devices, and applications, in accordance with one or more example embodiments. Referring to FIG. 7, at operation 710, user account information is received. At operation 720, a user account is generated using the user account information. At operation 730, content source registration information is received. At operation 740, the user account and a content source are associated using the content source registration information. At operation 750, storage target registration information is received. At operation 760, the user account and a storage target are associated using the storage target registration information. At operation 770, a request to access content information related to the content source is received. At operation 780, the content information is received in response to receiving the request to access the content information; and at operation 790, the content information is transmitted to the storage target in response to receiving the content information.

The various actions, acts, blocks, steps, or the like in the flow diagram 700 may be performed in the order presented, in a different order, or simultaneously. Further, in some embodiments, some of the actions, acts, blocks, steps, or the like may be omitted, added, modified, skipped, or the like without departing from the scope of the invention.

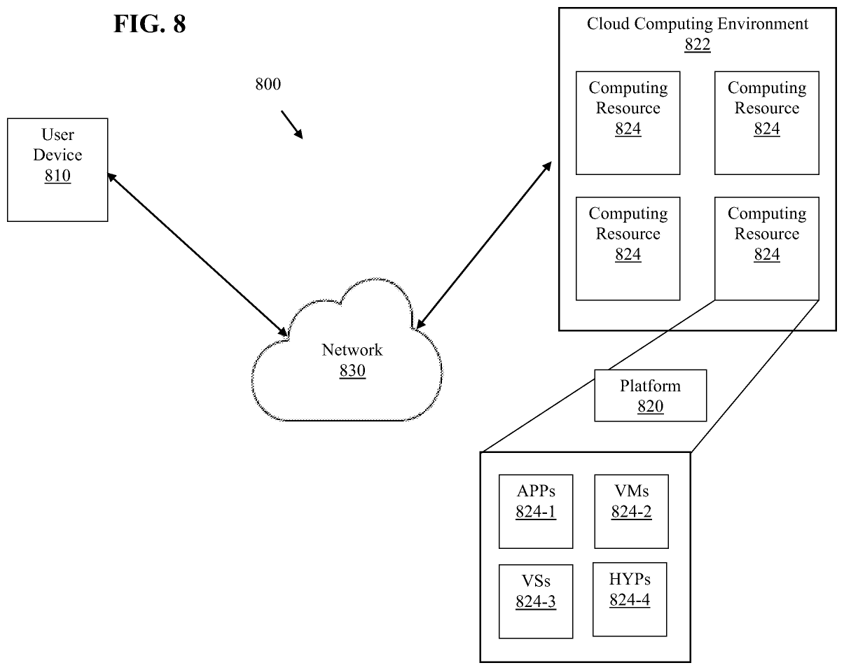

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIGS. 2 through 7 above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc., services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 includes one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

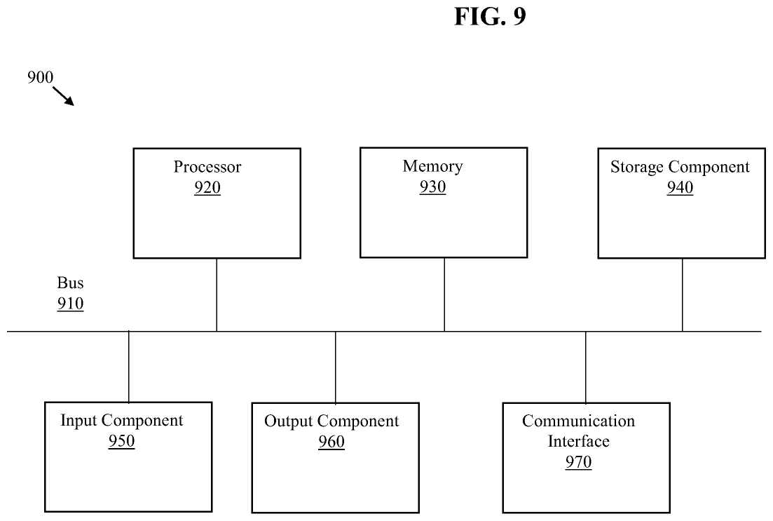

FIG. 9 is a diagram of example components of a device 900. Device 900 may correspond to user device 810 and/or platform 820. As shown in FIG. 9, device 900 may include a bus 910, a processor 920, a memory 930, a storage component 940, an input component 950, an output component 960, and a communication interface 970.

Bus 910 includes a component that permits communication among the components of device 900. Processor 920 may be implemented in hardware, firmware, or a combination of hardware and software. Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 includes one or more processors capable of being programmed to perform a function. Memory 930 includes a random access memory (RAM), a read only memory (ROM), and/or another type of dynamic or static storage device (e.g., a flash memory, a magnetic memory, and/or an optical memory) that stores information and/or instructions for use by processor 920.

Storage component 940 stores information and/or software related to the operation and use of device 900. For example, storage component 940 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 950 includes a component that permits device 900 to receive information, such as via user input (e.g., a touch screen display, a keyboard, a keypad, a mouse, a button, a switch, and/or a microphone). Additionally, or alternatively, input component 950 may include a sensor for sensing information (e.g., a global positioning system (GPS) component, an accelerometer, a gyroscope, and/or an actuator). Output component 960 includes a component that provides output information from device 900 (e.g., a display, a speaker, and/or one or more light-emitting diodes (LEDs)).

Communication interface 970 includes a transceiver-like component (e.g., a transceiver and/or a separate receiver and transmitter) that enables device 900 to communicate with other devices, such as via a wired connection, a wireless connection, or a combination of wired and wireless connections. Communication interface 970 may permit device 900 to receive information from another device and/or provide information to another device. For example, communication interface 970 may include an Ethernet interface, an optical interface, a coaxial interface, an infrared interface, a radio frequency (RF) interface, a universal serial bus (USB) interface, a Wi-Fi interface, a cellular network interface, or the like.

Device 900 may perform one or more processes described herein. Device 900 may perform these processes in response to processor 920 executing software instructions stored by a non-transitory computer-readable medium, such as memory 930 and/or storage component 940. A computer-readable medium is defined herein as a non-transitory memory device. A memory device includes memory space within a single physical storage device or memory space spread across multiple physical storage devices.

Software instructions may be read into memory 930 and/or storage component 940 from another computer-readable medium or from another device via communication interface 970. When executed, software instructions stored in memory 930 and/or storage component 940 may cause processor 920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

In embodiments, any one of the operations or processes of FIGS. 2 through 7 may be implemented by or using any one of the elements illustrated in FIGS. 8 and 9.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet service provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method, comprising:
receiving user account information;
generating a user account using the user account information;
receiving content source registration information;
associating the user account and a content source using the content source registration information;
receiving storage target registration information;
associating the user account and a storage target using the storage target registration information;
receiving a request to access content information related to the content source;
receiving the content information in response to receiving the request to access the content information; and
transmitting the content information to the storage target in response to receiving the content information.

2. The method of claim 1, further comprising:
communicating with an application programming interface in response to receiving the request to access the content information, and wherein:
receiving the content information comprises receiving the content information from the application programming interface.

3. The method of claim 2, wherein:
receiving the request to access the content information related to the content source comprises conducting a first transaction using a normalized communication protocol;
communicating with the application programming interface in response to receiving the request to access the content information comprises conducting a second transaction using a specialized communication protocol;
receiving the content information related to the request comprises conducting a third transaction using the specialized communication protocol; and
transmitting the content information to the storage target in response to receiving the content information comprises conducting a fourth transaction using the normalized communication protocol.

4. The method of claim 1, wherein:
receiving the content source registration information comprises receiving at least one content source input parameter used to communicate with a system connected to the content source; and
receiving the storage target registration information comprises receiving at least one storage target input parameter used to communicate with a system connected to the storage target.

5. The method of claim 1, further comprising:
generating a plurality of content options using the content information in response to receiving the content information; and
displaying, on an electronic device associated with the user account, the plurality of content options in response to generating the plurality of content options.

6. The method of claim 5, wherein:
transmitting the content information to the storage target further comprises transmitting the content information associated with a selected content option of the plurality of content options.

7. The method of claim 1, further comprising:
determining whether the content source is connected to a wireless network; and
upon determining the content source is connected to the wireless network, receiving the content information.

8. The method of claim 1, wherein further comprising:
determining whether the storage target is connected to a wireless network; and
upon determining the storage target is connected to the wireless network, transmitting the content information to the storage target.

9. The method of claim 1, wherein the content source comprises at least one of a vehicle, a portable handheld video recording device, a digital single-lens reflex camera, or a cloud storage application.

10. The method of claim 1, wherein the storage target comprises at least one of vehicle, a portable handheld video recording device, a digital single-lens reflex camera, or a cloud storage application.

11. A method, comprising:
receiving user account information;
generating a user account using the user account information;
receiving content source registration information relating to a plurality of content sources;
associating the user account and the plurality of content sources using the content source registration information;
receiving storage target registration information relating to a plurality of storage targets;
associating the user account and the plurality of storage targets using the storage target registration information;
receiving a request to access content information related to a selected content source of the plurality of content sources;
receiving the content information in response to receiving the request to access the content information;
receiving a request to transmit the content information to a selected storage target of the plurality of storage targets; and
transmitting the content information to the selected storage target of the plurality of storage targets in response to receiving the request to transmit the content information related to the selected content source of the plurality of content sources to the selected storage target of the plurality of storage targets.

12. The method of claim 11, further comprising:
communicating with an application programming interface in response to receiving the request to access the content information related to the selected content source of the plurality of content sources, and wherein:
receiving the content information related to the selected content source of the plurality of content sources comprises receiving the content information related to the selected content source of the plurality of content sources from the application programming interface.

13. The method of claim 12, wherein:
receiving the request to access the content information associated with a selected content source of the plurality of content sources comprises conducting a first transaction using a normalized communication protocol;
communicating with the application programming interface comprises conducting a second transaction using a specialized communication protocol;
receiving the content information related to the selected content source of the plurality of content sources comprises conducting a third transaction using the specialized communication protocol; and
transmitting the content information related to the selected content source of the plurality of content sources to the selected storage target of the plurality of storage targets comprises conducting a fourth transaction using the normalized communication protocol.

14. The method of claim 11, wherein:
receiving the content source registration information comprises receiving at least one content source input parameter used to communicate with a system connected to the content source;
receiving the storage target registration information comprises receiving at least one storage target input parameter used to communicate with a system connected to the storage target.

15. The method of claim 11, further comprising:
generating a plurality of content options using the content information related to the selected content source of the plurality of content sources in response to receiving the content information related to the selected content source of the plurality of content sources; and
displaying, on an electronic device associated with the user account, the plurality of content options in response to generating the plurality of content options.

16. The method of claim 11, wherein:
at least one content source of the plurality of the content sources is the same as at least one source target of the plurality of source targets.

17. The method of claim 11, further comprising:
determining, for each content source of the plurality of content sources, a content source connection status related to whether each content source of the plurality of content sources is connected to a wireless network; and
displaying, on an electronic device associated with the user account, the content source connection status of each content source of the plurality of content sources.

18. The method of claim 11, further comprising:
determining, for each storage target of the plurality of storage targets, a storage target connection status related to whether each storage target of the plurality of storage targets is connected to a wireless network; and
displaying, on an electronic device associated with the user account, the storage target connection status of each storage target of the plurality of storage targets.

19. The method of claim 11, wherein at least one content source of the plurality of content sources or at least one storage target of the plurality of storage targets comprise at least one of a vehicle, a portable handheld video recording device, a digital single-lens reflex camera, or a cloud storage application.

20. A non-transitory computer-readable medium for storing computer readable program code or instructions for carrying out operations when executed by a processor, the operations comprising:
receiving user account information;
generating a user account using the user account information;
receiving content source registration information;
associating the user account and a content source using the content source registration information;
receiving storage target registration information;
associating the user account and a storage target using the storage target registration information;
receiving a request to access content information related to the content source;
receiving the content information in response to receiving the request to access the content information; and
transmitting the content information to the storage target in response to receiving the content information.
